(19) United States
(12) Patent Application Publication
(10) Pub. No.: US 2025/0099869 A1
(43) Pub. Date: Mar. 27, 2025

(54) ARRANGEMENT FOR THE PRODUCTION OF TABLE SALT, ELECTRICITY GENERATION AND SEAWATER HEATING

(71) Applicant: Jose Miguel Tordecilla Suarez, Vina del Mar (CL)

(72) Inventor: Jose Miguel Tordecilla Suarez, Vina del Mar (CL)

(21) Appl. No.: 18/727,702

(22) PCT Filed: Dec. 21, 2022
(86) PCT No.: PCT/CL2022/050135

§ 371 Date: Jul. 10, 2024

(30) Foreign Application Priority Data
Jan. 13, 2022 (CL) 100-2022

(51) Int. Cl. B01D 1/20; B01D 1/00; C02F 1/12; C02F 103/08

(52) U.S. Cl. CPC B01D 1/20; B01D 1/0023; C02F 1/12; C02F 2103/08

(57) ABSTRACT

An arrangement which is composed of two systems, a mechanical system and an evaporation system, powered only by an electric motor, connected together by means of a cardan shaft system to a crankshaft, The crankshaft then moves a system of levers which by means of a gearbox gives speed to a system of pistons and radial cylinders of the mechanical system, which drive a Pelton turbine, which is driven by means of the mechanical system through the rings or cores S1, S2, S3 . . . connected to a rotation shaft to produce a rotating shaft. connected to a rotating shaft to produce the evaporation of seawater and desalination, a system which through different arrangements allows to generate heat energy, to heat the water and additionally to generate electrical energy.

### FIELD OF INVENTION

The present invention relates to a method and system of radial hydraulic injection core, for evaporating seawater so as to desalinate it for salt production and with different arrangements and minimum energy consumption at its input, generate either thermal or electrical energy and air-condition the water.

### BACKGROUND OF THE INVENTION

Aspects of this invention relate in general to systems and methods for the evaporation of seawater and for the generation of energy, since it is based on suitable mechanisms.

In the state of the art there are patents related to similar systems for seawater desalination, for example in the European patent No. WO2012108754A2 is described a process for desalinating seawater, which is mainly based on an improved filter, which is based on reverse osmosis, more oriented towards desalination rather than energy generation or air conditioning.

There are certain disadvantages related to seawater desalination systems and methods, which are related to high energy consumption, expensive equipment and impact on marine ecosystems.

On the other hand, pretreatment is necessary, where the membranes used for reverse osmosis are very sensitive. So, unless some more resistant membrane material is developed, pretreatment is an important requirement. Without it, the membrane can become virtually useless, decreasing performance or producing impure water. Improperly pretreated seawater can deposit particulates on the membrane. These contaminants affect the proper membrane flux and pressure, which increases the operating cost.

One embodiment of such a system and method can be found in U.S. Patent No. U.S. Pat. No. 4,333,832A relating to a rotary solution separation system, wherein salt water and other solutions are accelerated in a rotating structure and applied to a vessel containing reverse osmosis membrane material. The desalinated water is removed after passing through the large surface area of membrane material concentration in the vessel. The enriched brine is removed from the vessel at the point farthest from the axis of the rotating structure and is returned to the vicinity of the axis to avoid accumulation of dense material. The membrane material is configured in the vessel so that the flow is generally radial with respect to the axis of the rotating structure. It comes back to the same drawback of the problem related to filters.

### SUMMARY OF THE INVENTION

Aspects of the present invention can be used to advantageously provide a hydraulic radial injection core system, for the evaporation of water so as to desalinate seawater, with minimum energy consumption and additionally to generate either thermal or electrical energy.

The system can operate in industries for seawater desalination, air conditioning of homes and buildings, vacuum cooling, minimum and medium scale power generation with turbines, thermal generation for heating of industries, homes and buildings, food industries, wastewater industries.

### BRIEF DESCRIPTION OF THE FIGURES

FIG. 1, a schematic diagram of the operation of the systems, according to the invention, is observed.

FIG. 2, shows a schematic diagram of the connection of system 1 with system 2, by means of a Pelton turbine and gearboxes, for desalination, in accordance with the invention.

FIG. 3 shows a schematic diagram of the connection of system 1 with a Halbach Matrix, by means of a Pelton turbine, in such a way that of powering the neodymium magnets and inducing electric current to the induction plate and bar, for the generation of heat, in accordance with the invention.

FIG. 4, shows a schematic diagram of the connection of system 1 with system 2, by means of a Pelton turbine and gearboxes, in accordance with the invention.

### DETAILED DESCRIPTION OF THE INVENTION

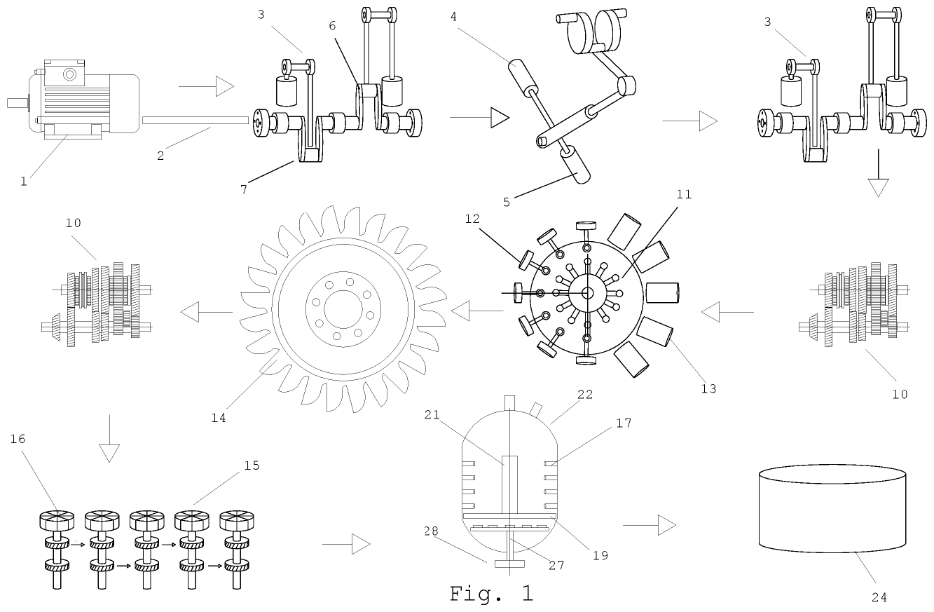

FIG. 1 shows parts of the mechanical system (29) of the arrangement, which is operated by means of a single electric motor (1), connected by means of cardan shafts (2) which move along a longitudinal extension, connected by means of crankshafts (3) (as hydraulic levers) which operate in an upward and downward direction arranged at an angle of 45°, using two compression pistons, one upper (4) and one lower (5), for the injection of liquid or air, thus taking advantage of both the rise and fall of the piston for the injection of hydraulic liquid. Once this process is finished, the hydraulic levers (9) of the first crankshaft (3) ascend from the PMI (7) to the PMS (6), and the second crankshaft

(3) ascends from the PMS (6) to the PMI (7).

The crankshaft (3) is arranged at a 30° angle of inclination, which avoids a very high torsional stress, allowing a complete cycle of the crankshafts (3) without major stresses.

Subsequently, these crankshafts (3) are connected by means of a gear box (10) to sections S1, S2, S3, S4 and S5 of rings or cores (8), being able to be used the sections that are needed according to the requirements. The gear box

(10) is connected to the radial injector (8), which allows the injection of air or liquid or both. Each core S1, S2, S3, S4 and S5, comprises two lifters, a hydraulic lever system (9), two crankshafts (3), a gearbox (10) and the radial injector (11).

Sections S1, S2, S3, S4 and S5, driven only by an electric motor (1) operate in unison.

Each section S1, S2 . . . acts directly and indirectly.

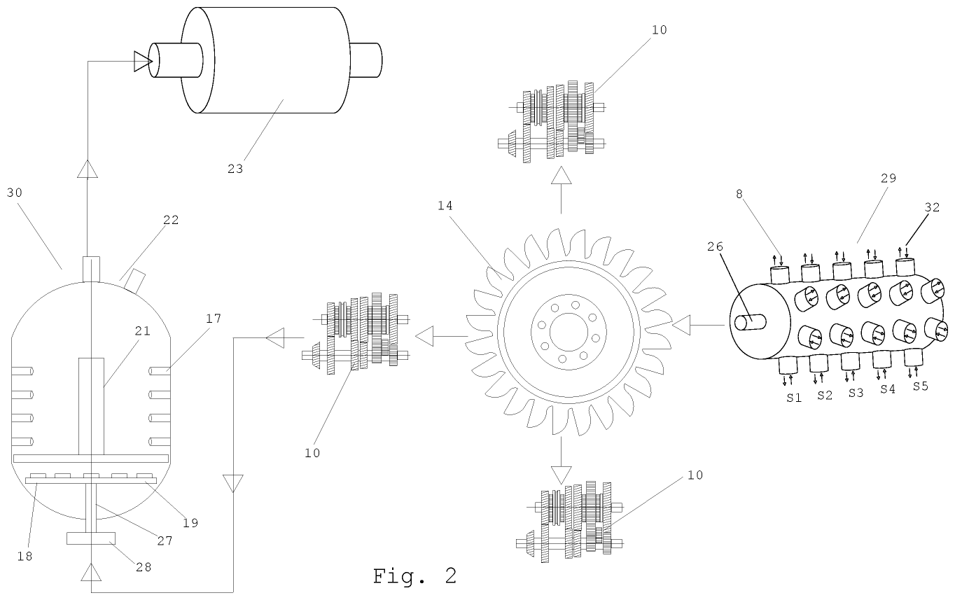

Example of layout, (see FIG. 2) the S1 section is responsible for inject enough m3 of hydraulic fluid to rotate a Pelton turbine (14), in this case S1 keeps in motion the Pelton turbine (14) which is connected by means of three gear boxes (10) that allow to have speeds and relieve the angular momentum, or angular torsion, These gear boxes (10) are connected to a central shaft (27) by means of a rotation gear (28). Additionally, the system is directly connected to an evaporation chamber (22).

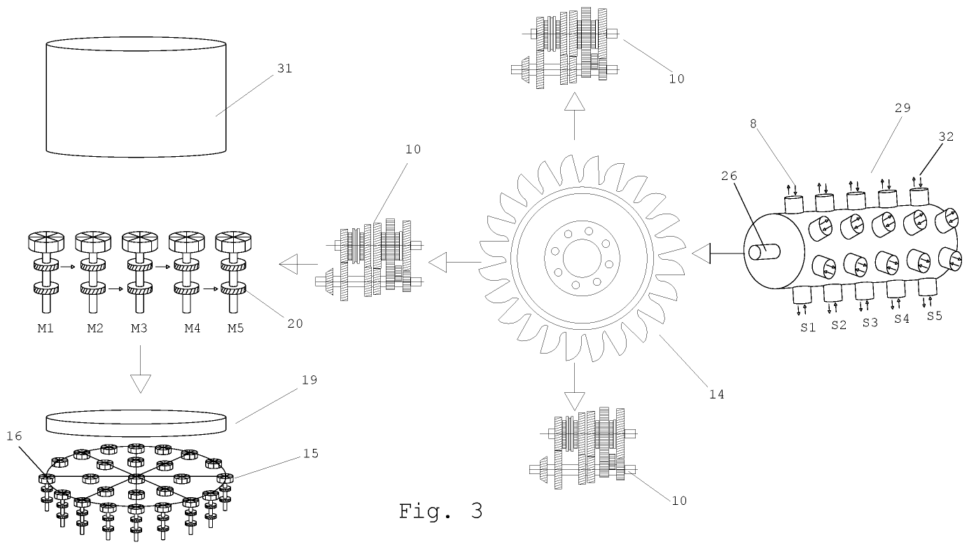

Once the system 1, injected hydraulic liquid, spun the Pelton turbine (14) and the gearboxes (10) were placed in gear, the gearboxes (10) are connected to a central shaft (27), which at its upper end is located a Halbach Matrix (15), provided with Neodymium magnets (16) arranged in a N, S, E, W arrangement, so as to neutralize for example the south pole of the field and enhance the north pole of the neodymium magnet arrangement (16) (see FIG. 3).

All this arrangement of neodymium magnets (16) is connected to the matrix C1 of neodymium magnets (15) (16) by means of a chain of gears, to the matrix 2 and so on, so as to generate a rotation. In FIG. 3, it can be seen under the matrix (15) of neodymium magnets (16), is located an induction plate (19) of aluminum or copper of cylindrical shape of lower height, where it is enough only with the rotation of a matrix (18) to generate a rotation, inducing an electric current in the induction plate (19), the current will dissipate all the energy generating thermal energy.

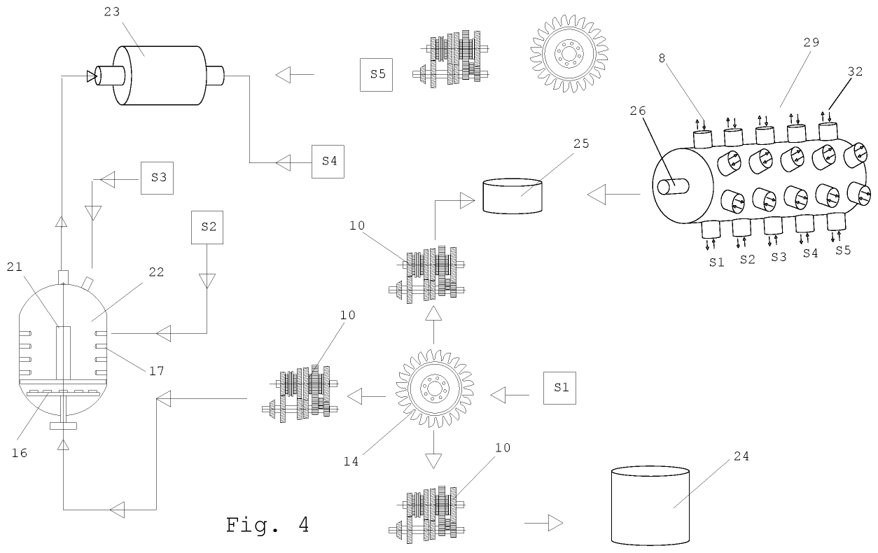

In FIG. 4, S1 is in charge of feeding a Pelton turbine (14), this Pelton turbine (14) gives torque to the gearbox (10), connected to a central shaft (27), inside the evaporation chamber (22), this central shaft (27) is connected to the Halbach matrix (15) which rotates and induces the inductive plate (19) and the induction bar (21).

S2 operates by aspirating seawater, which is injected by means of sprinklers or nozzles (17) under pressure as a spray in order to diffuse the water and lower the thermodynamic capacity of the seawater, so as to evaporate it faster.

S3 is responsible for lowering the pressure inside the evaporation chamber (22), the water can boil even at 10° Celsius, with all this heat induced by the matrix (15) of neodymium magnets (16), the low pressure, additionally produces evaporation to the water injected in the form of mist through the nozzles (17).

S4 is in charge of injecting air to the atmosphere exchanger (23), which takes all the water vapor from the evaporation chamber (22), transfers it to the inside of the atmosphere exchanger (23), working at 600 millibar, S4 injects air from the atmosphere, which passes through impurity filters, thus increasing the pressure inside the atmosphere exchanger (23), when it reaches the ambient pressure, the water increases its thermodynamic resistance, loses heat, the water becomes liquid and is recovered.

S5, is in charge of turning a Pelton turbine (14), by means of the gearbox (10), in order to suck all the steam from inside the evaporation chamber (22) and transfer it to the atmosphere exchanger (23). The gear box (10) transfers the liquid water to the final disposal (25), where it is analyzed and its solutes are checked and eventually it is seen if a reprocessing of it is required.

The second gear box (10) transports part of the salinity or brine from inside the evaporation chamber (22) to the drying chamber (24) and at ambient pressure operating with an array (15) of Neodymium magnets (16) with the difference that this chamber does not operate under pressure, inside this drying chamber (24) all the solute is dried so as to obtain table salt.

In a second mode, the whole of the mechanical system 1 (29) passes all its hydrodynamic capacity to a Pelton turbine (14), which gives torque to three gearboxes (10), rotates the Halbach matrices (15) with their neodymium magnets (16) connected to the rotating shaft (27), these matrices induce the induction plate (19), which heats the water at normal pressure and the two gear boxes (10) move the liquid through a system of

pipes in order to be able to heat the water and allow air-conditioning.

Using this same arrangement, the system when operating with a Pelton turbine (14), only one gearbox (10), can generate electricity, generating a high amount of power through the Pelton turbine (14) with minimal consumption at the inlet (FIG. 5).

Transforming an energy into a lot of synergy.

### INDUSTRIAL APPLICATION

The present invention according to its application finds use in the industry, and in particular in the mechanical industry, of seawater desalination, thermal plants, thermal or electrical power generation, water air conditioning, seawater evaporation, minimum energy consumption, 0 carbon emission.

### LIST OF REFERENCE NUMBERS

1 Electric motor
2 Cardan
3 Crankshaft
4 Upper piston
5 Lower piston
6 Top dead center
7 Bottom dead center
8 Rings or cores
9 Lever system
10 Gearbox
11 Radial injector
12 Cylinder system
13 Piston system
14 Pelton Turbine
15 Halbach matrix
16 Neodymium magnets
17 Spray nozzles
18 Matrix M1, M2, M3 . . .
19 Cu or Al inductor plate
20 Chain and gear system
21 Inductor bar
22 Evaporating chamber
23 Atmosphere exchanger
24 Drying chamber
25 Final disposition
26 Crankshaft shaft
27 Axis of rotation
28 Rotation gear
29 Mechanical system 1
30 Evaporation system 2
31 Water tank
32 Air or water compression and suction chamber

1-8. (canceled)

9. An arrangement comprising two systems, a mechanical system and an evaporation system, powered only by an electric motor, which includes a cardan shaft system connected to a crankshaft, the crankshaft then moves a system of levers which by means of a gearbox gives speed to a system of pistons and cylinders oriented radially around the crankshaft, which drive a Pelton turbine, which is driven by means of the mechanical system through twelve radial cylinders arranged in each section S1, S2, S3, S4 and S5, connected to a rotation axis, CHARACTERIZED because section S1, compresses hydraulic liquid to rotate a Pelton turbine (14) keeping it in motion and setting in motion some gear boxes (10) which are connected to a Halbach type magnet array (15) connected to an induction plate (19) of aluminum or copper inducing an electric current which dissipates all its energy generating thermal energy, section S2, operates by sucking sea water, this is injected by means of sprinklers or nozzles (17) under pressure as a spray in order to diffuse the water and lower the thermodynamic capacity of the seawater, so as to evaporate it more quickly, section S3, is responsible for lowering the pressure inside an evaporation chamber (22), with all this the heat induced by the matrix (15) of magnets the low pressure, produces additionally the evaporation to the water injected in the form of mist through the nozzles (17), section S4, is in charge of injecting air to an atmosphere exchanger (23), which takes all the water vapor from the evaporation chamber (22), transfers it inside the exchanger of atmospheres (23), which takes all the water vapor from the evaporation chamber (22), the S4 section injects air from the atmosphere, which passes through impurity filters, thus increasing the pressure inside the atmosphere exchanger (23), when it reaches the ambient pressure, the water increases its thermodynamic resistance, the last section S5, like section S1, rotates the Pelton turbine (14), by means of the gearbox (10), so as to suck all the vapour from inside the evaporation chamber (22) and transfer it into an atmosphere exchanger (23), where the gearbox (10) transfers the water to a final disposal (25), where it is analysed and its solutes are checked.

10. The arrangement according to claim 9, CHARACTERIZED in that a mechanical system (29) comprises radial injectors (11) which can be connected by means of the Pelton turbine (14) and three gearboxes (10) to an evaporation chamber for seawater (22), acting the arrangement of radial cylinders (12) S1 indirectly, injecting the required amount of 60 liters of hydraulic liquid or air, for the displacement of the turbine (14), if all 5 groups of radial cylinders are used, (12) can generate 300 liters of injection and subsequently activate the gearboxes (10).

11. The arrangement according to claim 10, CHARACTERIZED in that the mechanical system (29) passes all its hydraulic capacity to the Pelton turbine (14), which displaces three gearboxes (10), to displace a Halbach matrix type dies (15) which induce an induction plate (19), this plate (19) heats the water at normal pressure and the other two gearboxes (10) displace the liquid through piping circuits to heat and air-condition the water.

12. The arrangement according to claim 11, CHARACTERIZED in that the mechanical system (29) connected to an evaporation system (30), passes all its hydrodynamic capacity to the Pelton turbine (14), occupying gearboxes (10), to stationary rotate the Halbach arrays (15) which induce the induction plate (19), to generate electric currents resulting in a mirror image magnetic field which dissipates its energy in the form of heat inside the evaporation chamber.

13. The arrangement according to claim 12, CHARACTERIZED in that the Halbach matrix is composed of 12 magnets of neodymium, placing the 12 magnets side by side to form a circle which forms a matrix.
